(19) United States
(12) Patent Application Publication
(10) Pub. No.: US 2007/0171210 A1
(43) Pub. Date: Jul. 26, 2007

(54) VIRTUAL INPUT DEVICE PLACEMENT ON A TOUCH SCREEN USER INTERFACE

(76) Inventors: Imran Chaudhri, San Francisco, CA (US); Greg Christie, San Jose, CA (US); Bas Ording, San Francisco, CA (US)

Correspondence Address: BEYER WEAVER LLP, P.O. BOX 70250, OAKLAND, CA, 94612-0250, US

(21) Appl. No.: 11/696,693

(22) Filed: Apr. 4, 2007

Related U.S. Application Data
(63) Continuation of application No. 11/228,758, filed on Sep. 16, 2005.
Application No. 11/228,758 is a continuation-in-part of application No. 10/903,964, filed on Jul. 30, 2004.

(51) Int. Cl. G06F 3/041

(52) U.S. Cl. 345/173

(57) ABSTRACT

A display is generated on a touch screen of a computer. The display includes an application display, associated with an application executing on the computer, and a virtual input device display for a user to provide input to the application executing on the computer via the touch screen. In response to a virtual input device initiation event, initial characteristics of the virtual input device display are determined. Based on characteristics of the application display and the characteristics of the virtual input device display, initial characteristics of a composite display image are determined including the application display and the virtual input device display. The composite image is caused to be displayed on the touch screen.

### CROSS-REFERENCE TO RELATED APPLICATIONS

This application is a continuation of application Ser. No. 11/228,758 filed Sep. 16, 2005 from which priority under 35 U.S.C. § 120 is claimed, which is hereby incorporated by reference in its entirety, which application is a continuation-in-part of prior application Ser. No. 10/903,964, from which priority under 35 U.S.C. § 120 is claimed, which is hereby incorporated by reference in its entirety. This application is also related to the following co-pending applications: U.S. Ser. No. 10/840,862, filed May 6, 2004; U.S. Ser. No. 11/048,264, filed Jul. 30, 2004; U.S. Ser. No. 11/038,590, filed Jul. 30, 2004; Atty Docket No.: APLIP307X2 (U.S. Ser. No. 11/228,737), entitled “ACTIVATING VIRTUAL KEYS OF A TOUCH-SCREEN VIRTUAL KEYBOARD”, filed concurrently herewith; and Atty Docket No.: APLIP307X4 (U.S. Ser. No. 11/228,700), entitled “OPERATION OF A COMPUTER WITH TOUCH SCREEN INTERFACE”, filed concurrently herewith; all of which are hereby incorporated herein by reference in their entirety for all purposes.

### BACKGROUND

1. Technical Field

The present patent application relates to touch screen user interfaces and, in particular, relates to placement of a virtual input device, such as a virtual keyboard or other virtual input device, on a touch screen user interface.

2. Description of the Related Art

A touch screen is a type of display screen that has a touch-sensitive transparent panel covering the screen, or can otherwise recognize touch input on the screen. Typically, the touch screen display is housed within the same housing as computer circuitry including processing circuitry operating under program control. When using a touch screen to provide input to an application executing on a computer, a user makes a selection on the display screen by pointing directly to graphical user interface (GUI) objects displayed on the screen (usually with a stylus or a finger).

A collection of GUI objects displayed on a touch screen may be considered a virtual input device. In some examples, the virtual input device is a virtual keyboard. Similar to a conventional external keyboard that is not so closely associated with a display screen, the virtual keyboard includes a plurality of keys (“virtual keys”). Activation of a particular virtual key (or combination of virtual keys) generates a signal (or signals) that is provided as input to an application executing on the computer.

External keyboards and other external input devices, by their nature (i.e., being external), do not cover the display output of an application. On the other hand, virtual input devices, by virtue of being displayed on the same display screen that is being used to display output of executing applications, may cover the display output of such applications.

What is desired is methodology to intelligently display a virtual input device on a touch screen to enhance the usability of the virtual input device and the touch screen-based computer.

### SUMMARY

A display is generated on a touch screen of a computer. The display includes an application display, associated with an application executing on the computer, and a virtual input device display for a user to provide input to the application executing on the computer via the touch screen. In response to a virtual input device initiation event, initial characteristics of the virtual input device display are determined. Based on characteristics of the application display and the characteristics of the virtual input device display, initial characteristics of a composite display image are determined including the application display and the virtual input device display. The composite image is caused to be displayed on the touch screen.

This summary is not intended to be all-inclusive. Other aspects will become apparent from the following detailed description taken in conjunction with the accompanying drawings, as well as from the appended claims.

### BRIEF DESCRIPTION OF THE DRAWINGS

FIG. 1-1 is a block diagram of a touch-screen based computer system.

FIG. 1 illustrates, in accordance with an aspect, processing within a computer that results in a display on a touch screen.

FIG. 2 illustrates an example touch screen display output not including a virtual input device display.

FIGS. 3 and 3-1 illustrate example touch screen display outputs including both an application display and a virtual input device display, each with the application output display substantially unchanged from the FIG. 2 display.

FIGS. 4 and 5 illustrates an example touch screen displays where the spatial aspect of the application display is modified in accommodation of a virtual input device display.

FIG. 6 illustrates an example touch screen display in which an indication of the input appears in a portion of the display associated with a virtual input device.

FIGS. 7A, 7B and 7C illustrate a virtual input device display in various states of having been scrolled.

### DETAILED DESCRIPTION

Examples and aspects are discussed below with reference to the figures. However, it should be understood that the detailed description given herein with respect to these figures is for explanatory purposes only, and not by way of limitation.

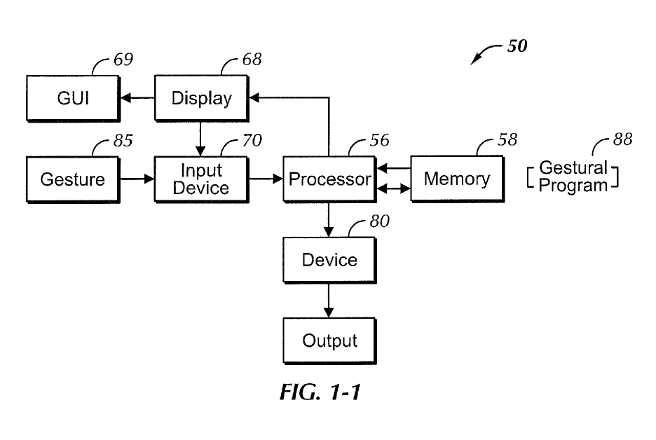

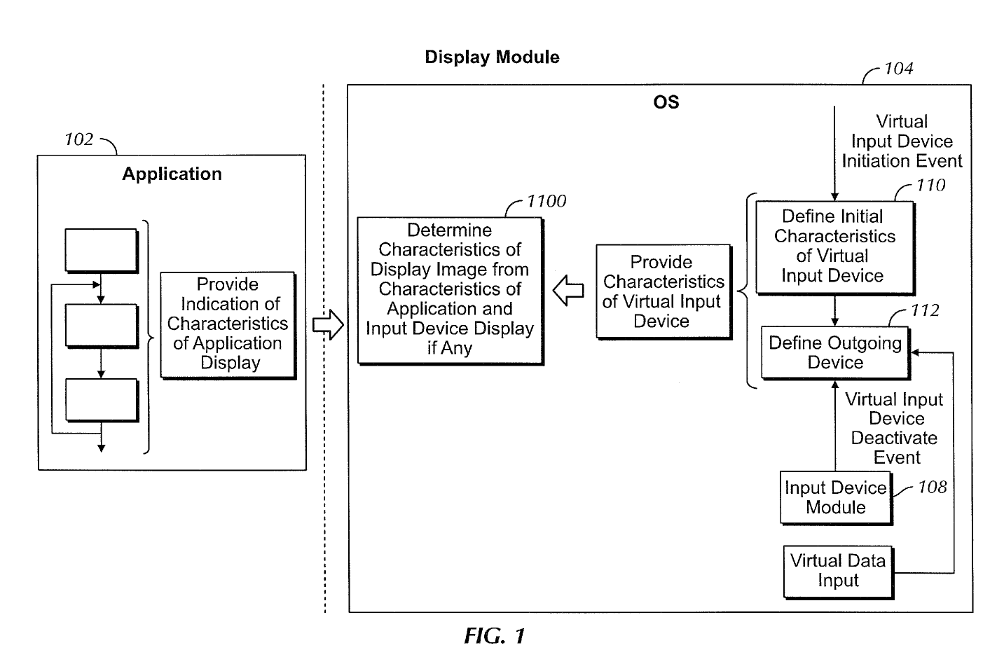

FIG. 1-1 is a block diagram of an exemplary computer system 50, in accordance with one embodiment of the present invention. The computer system 50 may correspond to a personal computer system, such as a desktops, laptops, tablets or handheld computer. The computer system may also correspond to a computing device, such as a cell phone, PDA, dedicated media player, consumer electronic device, and the like.

The exemplary computer system 50 shown in FIG. 1-1 includes a processor 56 configured to execute instructions and to carry out operations associated with the computer system 50. For example, using instructions retrieved for example from memory, the processor 56 may control the reception and manipulation of input and output data between components of the computing system 50. The processor 56 can be implemented on a single-chip, multiple chips or multiple electrical components. For example, various architectures can be used for the processor 56, including dedicated or embedded processor, single purpose processor, controller, ASIC, and so forth.

In most cases, the processor 56 together with an operating system operates to execute computer code and produce and use data. Operating systems are generally well known and will not be described in greater detail. By way of example, the operating system may correspond to Mac OS X, OS/2, DOS, Unix, Linux, Palm OS, and the like. The operating system can also be a special purpose operating system, such as may be used for limited purpose appliance-type computing devices. The operating system, other computer code and data may reside within a memory block 58 that is operatively coupled to the processor 56. Memory block 58 generally provides a place to store computer code and data that are used by the computer system 50. By way of example, the memory block 58 may include Read-Only Memory (ROM), Random-Access Memory (RAM), hard disk drive and/or the like. The information could also reside on a removable storage medium and loaded or installed onto the computer system 50 when needed. Removable storage mediums include, for example, CD-ROM, PC-CARD, memory card, floppy disk, magnetic tape, and a network component.

The computer system 50 also includes a display device 68 that is operatively coupled to the processor 56. The display device 68 may be a liquid crystal display (LCD) (e.g., active matrix, passive matrix and the like). Alternatively, the display device 68 may be a monitor such as a monochrome display, color graphics adapter (CGA) display, enhanced graphics adapter (EGA) display, variable-graphics-array (VGA) display, super VGA display, cathode ray tube (CRT), and the like. The display device may also correspond to a plasma display or a display implemented with electronic inks.

The display device 68 is generally configured to display a graphical user interface (GUI) 69 that provides an easy to use interface between a user of the computer system and the operating system or application running thereon. Generally speaking, the GUI 69 represents, programs, files and operational options with graphical images. The graphical images may include windows, fields, dialog boxes, menus, icons, buttons, cursors, scroll bars, etc. Such images may be arranged in predefined layouts, or may be created dynamically to serve the specific actions being taken by a user. During operation, the user can select and activate various graphical images in order to initiate functions and tasks associated therewith. By way of example, a user may select a button that opens, closes, minimizes, or maximizes a window, or an icon that launches a particular program. The GUI 69 can additionally or alternatively display information, such as non interactive text and graphics, for the user on the display device 68.

The computer system 50 also includes an input device 70 that is operatively coupled to the processor 56. The input device 70 is configured to transfer data from the outside world into the computer system 50. The input device 70 may for example be used to perform tracking and to make selections with respect to the GUI 69 on the display 68. The input device 70 may also be used to issue commands in the computer system 50. The input device 70 may include a touch sensing device configured to receive input from a user's touch and to send this information to the processor 56.

By way of example, the touch-sensing device may correspond to a touchpad or a touch screen. In many cases, the touch-sensing device recognizes touches, as well as the position and magnitude of touches on a touch sensitive surface. The touch sensing means reports the touches to the processor 56 and the processor 56 interprets the touches in accordance with its programming. For example, the processor 56 may initiate a task in accordance with a particular touch. A dedicated processor can be used to process touches locally and reduce demand for the main processor of the computer system. The touch sensing device may be based on sensing technologies including but not limited to capacitive sensing, resistive sensing, surface acoustic wave sensing, pressure sensing, optical sensing, and/or the like. Furthermore, the touch sensing means may be based on single point sensing or multipoint sensing. Single point sensing is capable of only distinguishing a single touch, while multipoint sensing is capable of distinguishing multiple touches that occur at the same time.

The input device 70 may be a touch screen that is positioned over or in front of the display 68. The touch screen 70 may be integrated with the display device 68 or it may be a separate component. The touch screen 70 has several advantages over other input technologies such as touchpads, mice, etc. For one, the touch screen 70 is positioned in front of the display 68 and therefore the user can manipulate the GUI 69 directly. For example, the user can simply place their finger over an object to be controlled. In touch pads, there is no one-to-one relationship such as this. With touchpads, the touchpad is placed away from the display typically in a different plane. For example, the display is typically located in a vertical plane and the touchpad is typically located in a horizontal plane. In addition to being a touch screen, the input device 70 can be a multipoint input device. Multipoint input devices have advantages over conventional singlepoint devices in that they can distinguish more than one object (finger). Singlepoint devices are simply incapable of distinguishing multiple objects. By way of example, a multipoint touch screen, which can be used herein, is shown and described in greater detail in copending and commonly assigned U.S. patent application Ser. No. 10/840,862, which is hereby incorporated herein by reference.

The computer system 50 also includes capabilities for coupling to one or more I/O devices 80. By way of example, the I/O devices 80 may correspond to keyboards, printers, scanners, cameras, speakers, and/or the like. The I/O devices 80 may be integrated with the computer system 50 or they may be separate components (e.g., peripheral devices). In some cases, the I/O devices 80 may be connected to the computer system 50 through wired connections (e.g., cables/ports). In other cases, the I/O devices 80 may be connected to the computer system 80 through wireless connections. By way of example, the data link may correspond to PS/2, USB, IR, RF, Bluetooth or the like.

Particular processing within a touch-screen based computer is now described, where the processing accomplishes execution of an application as well as providing a display on the touch screen of the computer. The display processing includes providing a composite display that has characteristics based on the application display as well as characteristics relative to a virtual input device. The virtual input device display includes at least an input portion, to receive appropriate touch input to the touch screen relative to the displayed input device, for a user to interact with the virtual input device. The user interaction with the virtual input device includes activating portions of the virtual input device to provide user input to affect the application processing. The virtual input device (i.e., processing on the computer to accomplish the virtual input device) processes the user interaction and, based on the processing, provides the corresponding user input to the application.

The virtual input device display is typically highly correlated to the virtual input device processing of user interaction with the virtual input device. For example, if the virtual input device is a virtual keyboard, the virtual input device display may include a graphic representation of the keys of a typical QWERTY keyboard, whereas virtual input device processing of user interaction with the virtual keyboard includes determining which virtual keys have been activated by the user and providing corresponding input (e.g., letters and/or numbers) to the application.

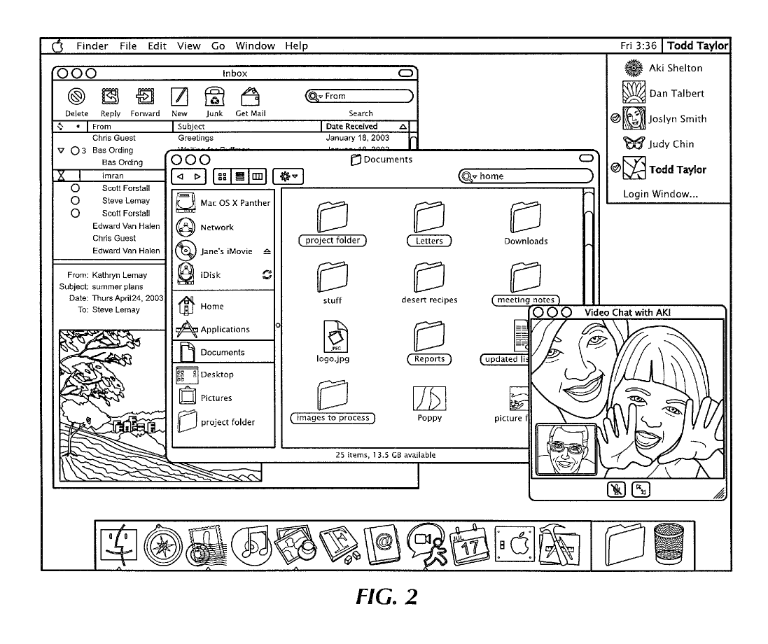

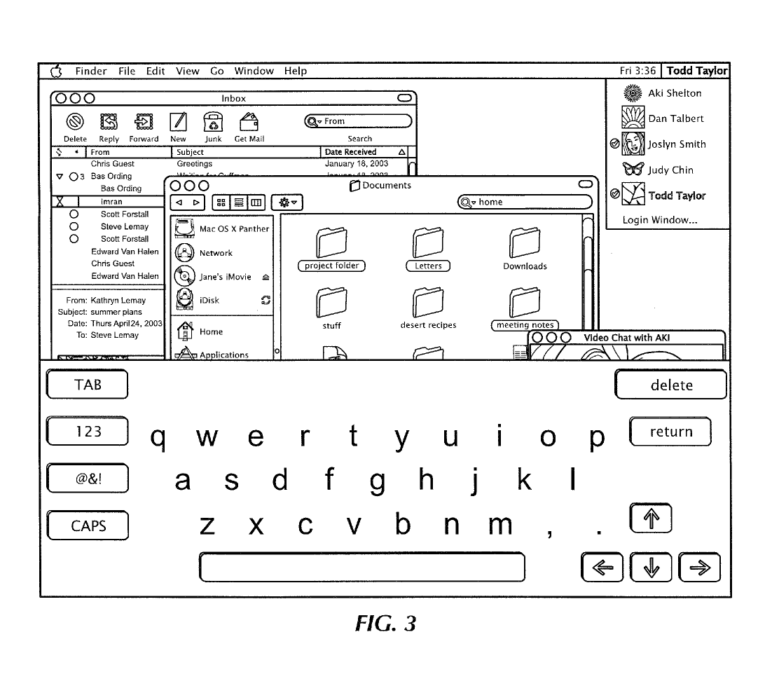

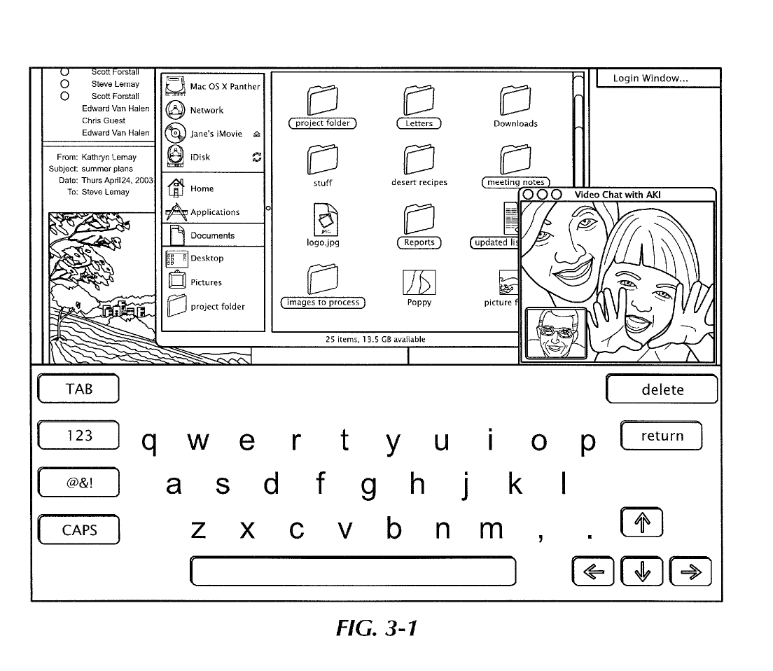

Reference is made now to FIGS. 1, 2, 3 and 3-1. FIG. 1 broadly illustrates processing to accomplish the composite display (i.e., composite of the application display and the virtual input device display) on the touch screen. FIG. 2 illustrates an example of an application display on a touch screen, without a virtual input device being displayed on the touch screen. FIG. 3 schematically illustrates an example composite display, whose components include an application display and a virtual input device display.

Referring first to FIG. 1, a flowchart illustrates processing steps executing on a computer such as the touch screen based computer illustrated in FIG. 1-1. First, processing steps of an application 102 executing on a computer are abstractly illustrated. The application may be, for example, an e-mail client program, word processing program or other application program. The application 102 executes in cooperation with an operating system program 104 executing on the computer. In particular, the operating system 104 provides the executing application 102 with access to resources of the computer. One resource to which the operating system 104 provides access is the touch screen.

The application 102 provides to the operating system 104 an indication of the characteristics of the application display. Broadly speaking, the indication of the characteristics of the application display includes data that, at least in part, is usable by the operating system to cause the application display to be generated on the touch screen.

The application display characteristics provided from the application 102 are typically related to a result of processing by the application. At least some of the characteristics of the application display may be known to, and/or controlled by, the operating system without the indication being provided by the application. These types of characteristics would typically be more generically display-related, such as “window size” of a window of the application display and background color of the window of the application display.

Given the characteristics of the application display, display processing 106 of the operating system program 104 determines the characteristics of a resulting display image, to be displayed on the touch screen, based at least in part on the indication of application display characteristics.

In addition, the operating system program 104 includes virtual keyboard processing 108. More generally, the processing 108 may be processing for any virtual input device that is displayed on the touch screen and that receives user input from the touch screen. Initial characteristic processing 110 of the virtual keyboard processing 108 responds to a keyboard initiation event and determines initial display characteristics of the virtual keyboard. Ongoing characteristic processing 112 of the virtual keyboard processing 108 determines ongoing display characteristics of the virtual keyboard, typically based on activation of the virtual keys of the virtual keyboard but possibly also based on other conditions. (While the discussion here is relative to display characteristics of the virtual keyboard, it should be appreciated that operational characteristics of the virtual keyboard, such as mapping of keys to application input, are often intertwined with the display characteristics. The determined display characteristics of the virtual keyboard are provided to the display processing 106.

The display processing 106 determines characteristics of a composite display, including displaying the virtual input device, based on the indicated characteristics of the virtual input device, in view of the indication of characteristics of the application display. More specifically, the virtual input device portion of the composite display is intelligent with respect to the characteristics of the application display. This is particularly useful, since the same touch screen is being used for both the virtual input device display output and the application display output. Displaying the virtual input device in a particular way for a particular application (i.e., for particular application display characteristics) can improve the usability of the touch screen to interact with the application using the virtual input device.

As mentioned above, FIG. 2 illustrates an application display, without display of a virtual input device.

In accordance with an example, illustrated in FIG. 3, a resulting composite display is such that the application display (e.g., illustrated in FIG. 2) is substantially unchanged except, however that the virtual input display is overlaid on top of a portion, but not all, of the application display. In accordance with another example, illustrated in FIG. 3-1, a resulting composite display is such that the application display (e.g., illustrated in FIG. 2) is substantially unchanged except, however, that the application display is “slid up” and the virtual input device is displayed in the portion of the touch screen vacated by the “slid up” application display.

The display processing 106 accounts for the indicated characteristics of the application display to determine the location of the virtual input device display in the composite display on the touch screen. For example, the display processing 106 may determine characteristics of the composite display such that significant portions of the application display, such as an input field associated with the application display (and the virtual input device), are not covered by the virtual keyboard display.

That is, an input field of an application display is typically determined to be significant because it may represent the portion of the application with which the user is interacting via the virtual input device. However, other portions of the application display may be determined to be significant. For example, a portion of the application display that is directly affected by input via the virtual input device may be determined to be significant. In some examples, there may not even be an input field of the application display.

What is determined to be significant may be a function of a particular application and/or application display, or may be a function of characteristics of applications in general. In some situations, portions of the application display other than the input field may be relatively significant so as to warrant not being covered in the composite display by the virtual input device display. The relative significance may be context-dependent. For example, the relative significance may be dependent on a particular mode in which the application is operating.

In accordance with some examples, rather than the application display being substantially unchanged (such as is illustrated in FIG. 3 and FIG. 3-1, the display processing 106 determines characteristics of the composite display such that, while substantially all the information on the application display remains visible within the composite display, the application display is modified in the composite display to accommodate the virtual input device display. In some examples, the display processing 106 determines characteristics of the composite display such that the spatial aspect of the application display is adjusted to provide room on the composite display for the virtual input device while minimizing or eliminating the amount of information on the application display that would otherwise be obscured on the composite display by the virtual input device display.

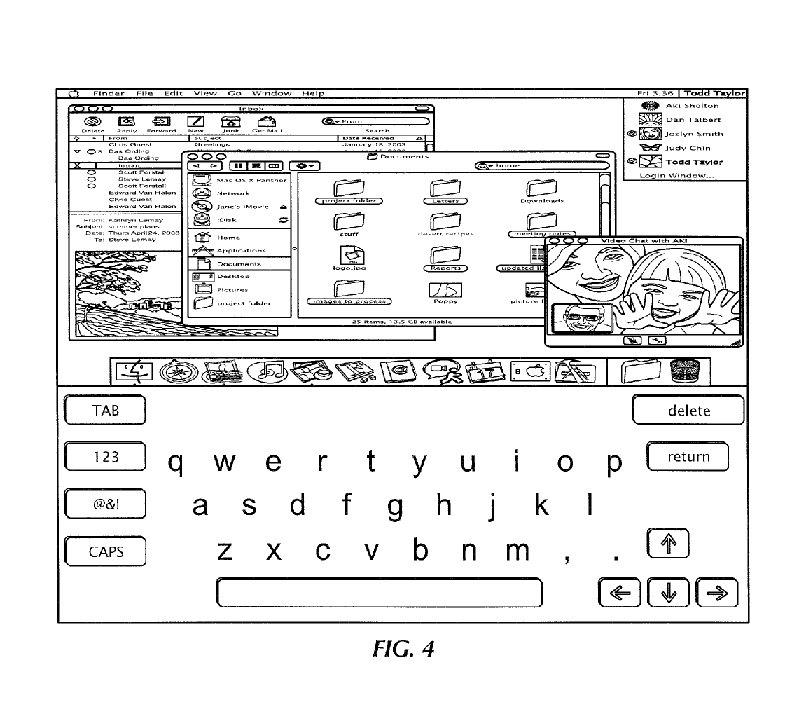

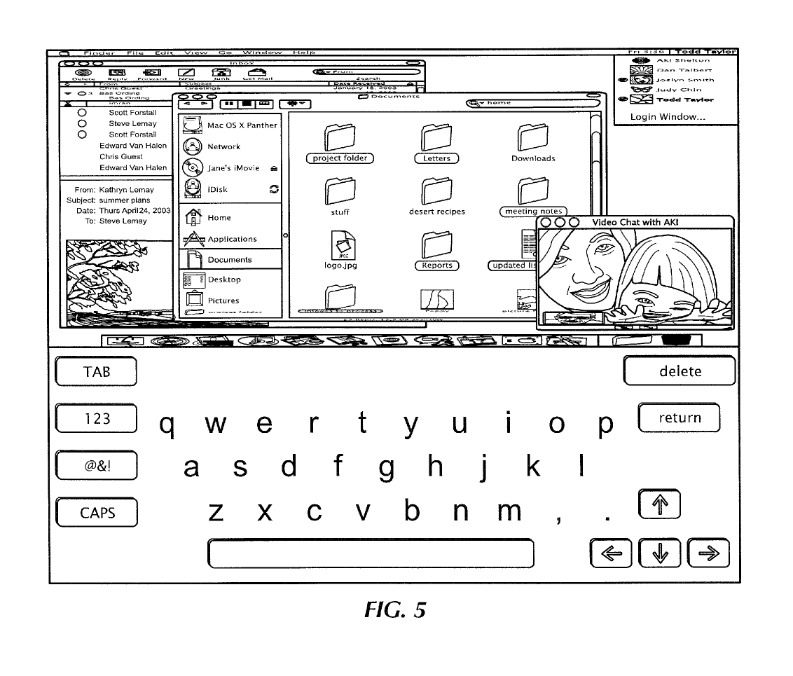

In some examples, at least one portion of the application display is compressed on the composite display to accommodate the virtual input device display. FIG. 4 illustrates one example where all portions of the application display are substantially equally compressed on the composite display, in one orientation. FIG. 5 illustrates another example, where less than all portions of the application display are compressed on the composite display. In other examples, portions of the application display are expanded on the composite display where, for example, these portions of the application display are significant with respect to the virtual input device.

In some examples, which portion or portions of the application display are compressed on the composite display is based on the characteristics of the application display. For example, some portions of the application display determined to be of greater significance may not be compressed, whereas other portions of the application display determined to be of lesser significance may be compressed. In some examples, the amount by which a particular portion of the application display is compressed is based on the relative significance of that portion of the application display. Different portions of the application display may be compressed (or expanded) by different amounts in the composite display, including no change in spatial aspect.

In yet other examples, characteristics of the virtual input device on the composite display may be user configurable, as a preset condition and/or the characteristics of the virtual input device display can be dynamically configured. As an example of dynamic configuration, the user may change the position of the virtual input device display in the composite display by touching a portion of the virtual keyboard display and “dragging” the virtual input device display to a desired portion of the composite display.

In some examples, the application display component itself, in the composite display, does not change as the user causes the characteristics of the virtual input device display, in the composite display, to change. Thus, for example, if the user causes the position of the virtual input device display, in the composite display, to change, different portions of the application display are covered as the virtual input device display is moved. In other examples, the display processing 106 makes new determinations of the characteristics of the application display, in the composite display, as the user causes the characteristics of the virtual input device display to change. For example, the display processing 106 may make new determinations of which portions of the application display to compress in the composite display based at least in part on the new positions of the virtual input device display in the composite display.

We now discuss the virtual input device initiation event (FIG. 1) in more detail. In particular, there are various examples of events that may comprise the virtual input device initiation event, to cause the virtual input device to be initially displayed as part of the composite display. The virtual input device may be displayed as part of the composite display, for example, in response to specific actions of the user directly corresponding to a virtual input device initiation event. In accordance with one example, the application has an input field as part of the application display, and a user gesture with respect to the input field may cause the virtual input device initiation event to be triggered. The user gesture may be, for example, a tap or double tap on the portion of the touch screen corresponding to the display of the input field. Typically, the operating system processing 104 includes the processing to recognize such a user gesture with respect to the input field and to cause the virtual input device initiation event to be triggered.

As another example of an event that may cause the virtual input device initiation event to be triggered, there may be an “on screen” button displayed as part of the application display, the activation of which by the user is interpreted by the operating system processing 104 and causes a virtual input device initiation event to be triggered. As yet another example, an on-screen button may be associated with the operating system more generally and, for example, displayed on a “desktop” portion of the touch screen associated with the operating system, as opposed to being specifically part of the application display. Activating the on-screen button in either case causes the virtual input device initiation event to be triggered, and the initial input device processing 110 is executed as a result.

As yet another example, the keyboard initiation event may be triggered by the user putting her fingers on the touch screen (for example, a multipoint touch screen) in a “typing” position. The detection of this user action may trigger a virtual keyboard initiation event, based on which the initial keyboard processing 110 is executed and the virtual input device is displayed as part of the composite display. In this case, for example, the operating system processing 104, interacting with the touch screen hardware and/or low level processing, is made aware of the user input to the touch screen. Such awareness may be in the form, for example, of coordinates of points that are touched on the touch screen. When a combination of such points, touched on the touch screen, are determined to correspond to a user putting her fingers on the touch screen in a “typing” position, then a virtual keyboard initiation event is triggered. The processing to determine that the combination of points correspond to a user putting her fingers on the touch screen in a “typing” position, such that a virtual input device initiation event is to be triggered, may be allocated to the operating system processing 104 or may be, for example, processing that occurs in conjunction or cooperation with operating system processing 104.

We now discuss more details with respect to the virtual input device deactivate event. As illustrated in FIG. 1, triggering of a virtual input device deactivate event causes the virtual input to cease to be displayed as part of a composite display on the touch screen. The virtual input device deactivate event may, for example, be triggered as a result of an action specifically taken by the user with respect to the virtual input device directly. This may include, for example, activating a specific “deactivate” key on the virtual input device display to cause the virtual input device to cease to be displayed as part of the composite display. An interaction with the application more generally, but not necessarily specifically by activating a key on the virtual input device, may cause a deactivation event to be triggered.

One example of such an interaction includes an interaction with the display of the executing application in a way such that providing input via a virtual input device is not appropriate. Another example includes interacting with the application (via the application display or via the virtual keyboard display, as appropriate) to close the application. Yet another example includes a gesture (such as “wiping” a hand across the keyboard) or activating the virtual return key in combination with “sliding” the fingers off the virtual return key, which causes the “return” to be activated and then causes the virtual keyboard to be dismissed.

As yet another example, triggering a deactivation event may be less related to particular interaction with the virtual input device specifically, or the touch screen generally but may be, for example, caused by a passage of a particular amount of time since a key on the virtual input device was activated. That is, disuse of the virtual input device for the particular amount of time would imply that the virtual keyboard is no longer to be used. In yet another example, a deactivation event may be triggered by the application itself, such as the application triggering a deactivation event when the state of the application is such that display of the virtual input device is deemed to be not required and/or appropriate.

We now discuss various modes of operation of a virtual input device. In one example, input (typically, but not limited to, text) associated with activated keys may be provided directly to, and operated upon by, the application with which the application display corresponds. An indication of the input may even be displayed directly in an input field associated with the application.

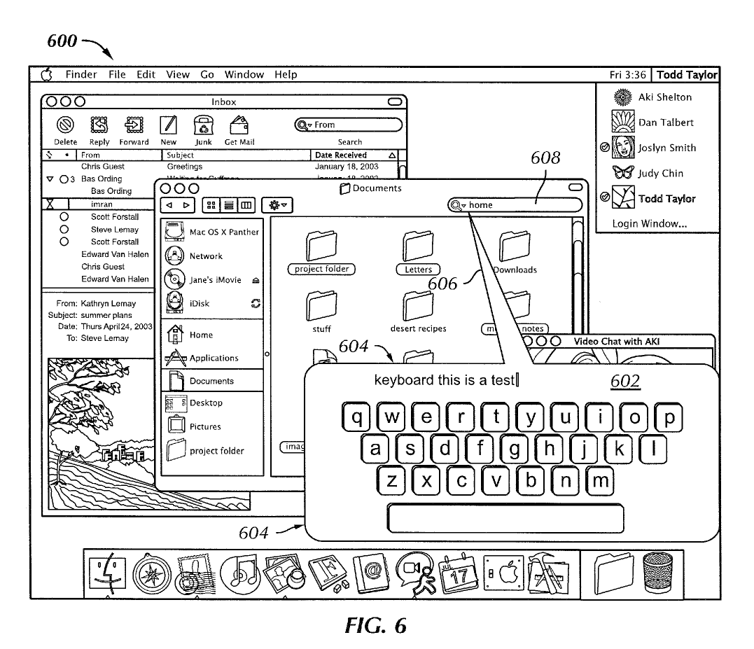

In other examples, an example of which is illustrated in FIG. 6, an indication of the input may appear in a portion 604 of the display associated with the virtual input device 602, but not directly associated with the application display. Input may then be transferred to the application (directly, to be acted upon by the application, or to an input field 608 associated with the application display) either automatically or on command of the user. In accordance with one example, automatic transfer occurs upon input via the virtual input device 602 of “n” characters, where “n” may be a user-configurable setting. In accordance with another example, automatic transfer occurs every “m” seconds or other units of time, where “m” may be a user-configurable setting.

In some examples, the virtual input device display 602 includes a visual indicator 606 associated with the virtual input device 602 and the input field 608 of the application display. Referring to the example display 600 in FIG. 6, the virtual input device display 602 includes the visual indicator arrow 606, which points from the virtual input device display 602 to a corresponding input field 606 of the application display. The visual indicator 606 is not limited to being a pointer. As another example, the visual indicator 606 may be the input field 608 of the application field being highlighted.

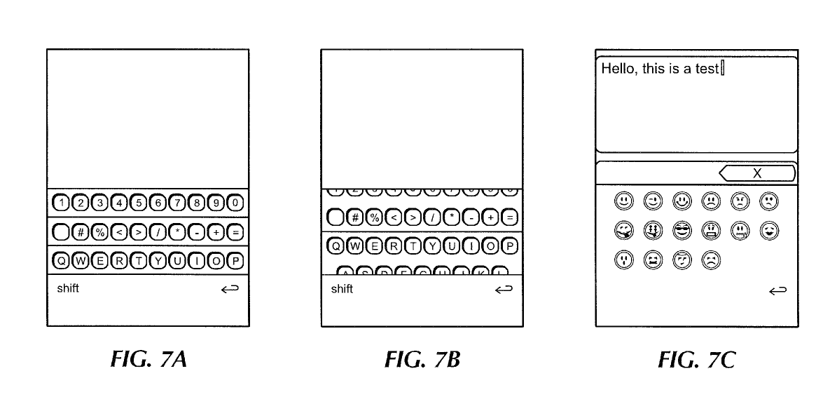

In some examples, the display associated with the virtual input device displayed in a window that is smaller than the virtual input device itself (and, the size of the window may be user-configurable). In this case, the user may activate portions of the virtual input device display to scroll to (and, thus, access) different portions of the virtual input device display. FIGS. 7A, 7B and 7C illustrate a virtual input device display in various states of having been scrolled. The scrolling may even be in more than two dimension (e.g., a virtual cube, or a virtual shape in more than three dimensions), to access non-displayed portions of the virtual input device.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer system comprising:
a processor configured to execute instructions retrieved from a memory to control reception and manipulation of input and output data between components of the computing system.
a touch screen operable as a display device to display a graphical user interface and operable as an input device to allow manipulation of the graphical user interface using one or more virtual input devices;
wherein the processor's control of the reception and manipulation of input and output data comprises:
providing a composite display on the display device that has characteristics intelligently selected based on an application display and based on a virtual input device.
